(19) United States
(12) Patent Application Publication
(10) Pub. No.: US 2016/0366393 A1
(43) Pub. Date: Dec. 15, 2016

(54) THREE-DIMENSIONAL ADVANCED IMAGING

(71) Applicant: Intel IP Corporation, Santa Clara, CA (US)

(72) Inventor: Walter Kodim, Stein (DE)

(73) Assignee: INTEL IP CORPORATION, Santa Clara, CA (US)

(21) Appl. No.: 14/736,345

(22) Filed: Jun. 11, 2015

(51) Int. Cl. H04N 13/02; G06T 11/60; H04N 5/232

(52) U.S. Cl. CPC H04N 13/0239; H04N 13/0296; H04N 5/23203; G06T 11/60

(57) ABSTRACT

Methods and systems are provided to manage a session to receive at least a first image from a first imaging device and a second image from a second imaging device, generate one or more vectors between the first imaging device and a focus of interest and between the second imaging device and the focus of interest, and generate a three-dimensional image based on the vectors and at least the first image and the second image.

### BACKGROUND

During special events, multiple users with imaging devices may each attempt to capture substantially similar content. Typically, this content may be a scene focal point such as a goal keeper defending a goal, musicians on a stage, or a bride and groom exiting a wedding venue. Each image may be limited to a particular user's position; for events with ticketed seating or congested crowds, it may be difficult to change the user's position to obtain a different perspective on the focal point. Further, due to variations of a scene with time, a user moving his position may lose content during the time it takes to move to a new location.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a three-dimensional imaging system;

FIG. 2 is a block diagram of an example of a three-dimensional imaging apparatus according to an embodiment;

FIG. 3 is a flowchart of an example of a method of three-dimensional imaging according to an embodiment;

FIG. 4 is an example of statistical information superposed on an image according to an embodiment;

FIG. 5 is a block diagram of an example of a system having a navigation controller according to an embodiment; and

FIG. 6 is a block diagram of an example of a system having a small form factor according to an embodiment.

### DETAILED DESCRIPTION

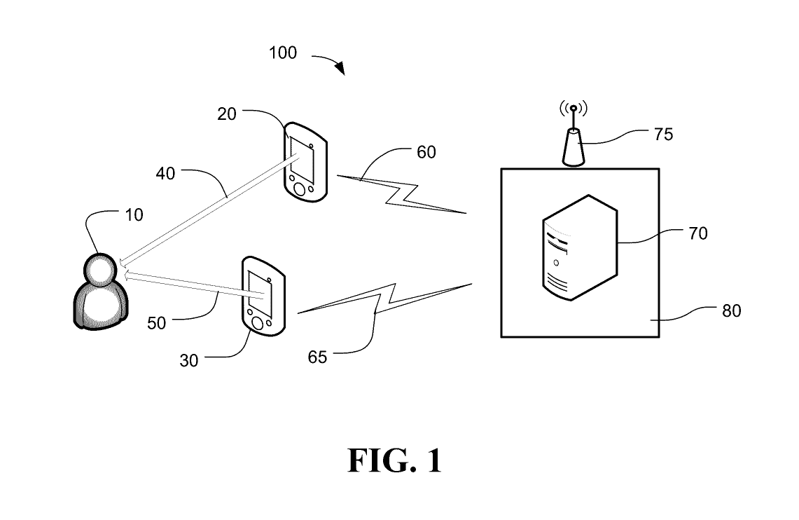

FIG. 1 shows a three-dimensional imaging system 100 according to an embodiment. The system 100 is directed towards a focus of interest 10. The focus of interest 10 may be an object or scene that may be viewed by multiple users who desire to capture images of the focus of interest 10. A first imaging device 20 and a second imaging device 30 may be oriented to the focus of interest 10. A first imaging device vector 40 and a second imaging device vector 50 may give the distance and direction from the first imaging device 20 to the focus of interest 10 and the distance and direction from the second imaging device 30 to the focus of interest 10, respectively. The first imaging device 20 and the second imaging device 30 may be any device that can capture a digital image of the focus of interest 10. Such devices include cameras, mobile phones, smart phones, tablets, personal digital assistants or any other device that may capture a digital image. The first imaging device 20 and the second imaging device 30 may be the same or different types of devices.

To create a three-dimensional image from at least a first image from the first imaging device 20 and at least a second image from the second imaging device 30, the first imaging device 20 may wirelessly transmit a first image over a first wireless communication path 60. Likewise, the second imaging device 30 may wirelessly transmit a second image over a second wireless communication path 65. Each of the wireless transmissions 60, 65 may be received by an antenna 75 that communicates the information to an apparatus 70, to be discussed in greater detail below. The apparatus 70 and the antenna 75 may be part of a mobile communication network base station 80, also known as an Evolved Node B (e-Node-B) in Long Term Evolution (LTE) networks. Alternatively, the apparatus 70 may be a stand-alone wireless node.

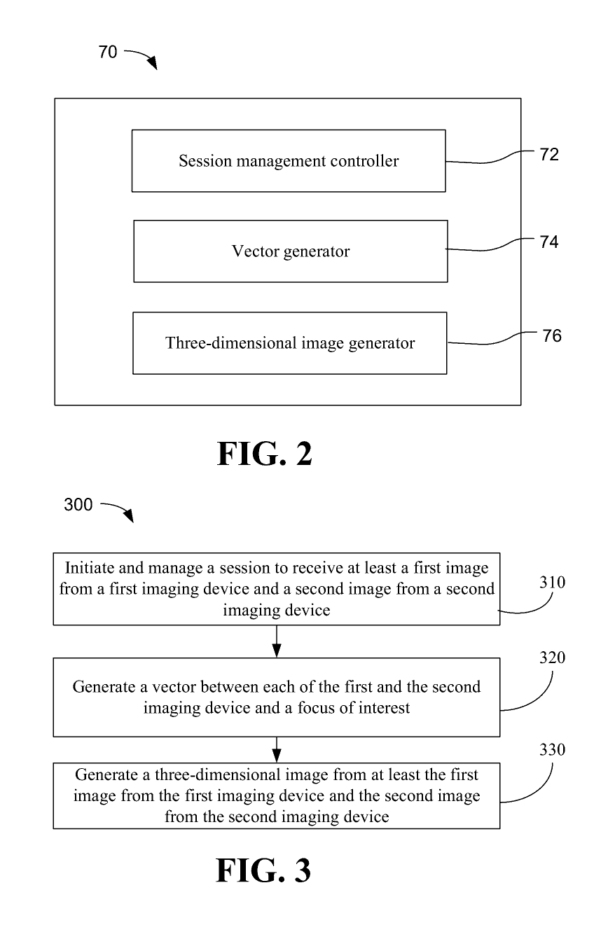

Turning now to FIG. 2, with continued reference to FIG. 1, a block diagram of the apparatus 70 is depicted in greater detail. The illustrated apparatus 70 includes a session management controller 72, a vector generator 74 that derives vector information that may be used in a later operation (described below), and a three dimensional image generator 76. As will be discussed in more detail below, the session management controller 72 may perform initial set-up of an imaging session among imaging devices and may coordinate view perspectives of the first imaging device 20 and the second imaging device 30. The session management controller 72 may gather statistical information about the focus of interest 10. The session management controller 72 may wirelessly communicate with the first imaging device 20 over the first wireless communication path 60 and with the second imaging device 30 over the second wireless communication path 65. The session management controller 72 may also provide imaging feedback to the first imaging device 20 and the second imaging device 30. In some instances, the session management controller 72 may remotely control imaging performed by the first imaging device 20 and/or the second imaging device 30. The expression “remotely control” may include mechanisms such as the session management controller 72 sending a message to a user of an imaging device 20 or 30 to “take a picture now” and the user operating an image capture button on the imaging device. Alternatively, the user may set imaging device 20 or 30 such that the session management controller 72 may be permitted to remotely trigger action for a defined period of time (e.g., a “trigger window”).

In a remote control operation, synchronization between the imaging devices 20 and 30 may be performed. Note that the session management controller 72 may coordinate with other imaging devices in the same session and that the first imaging device 20 and the second imaging device 30 are merely representative of a group of imaging devices capturing the focus of interest 10. It is understood that imaging devices may be “manned” (manipulated by a user) or “unmanned” without a user present (e.g., set to automatically record images or be remotely controlled to record images), including the use of unmanned drones.

The vector generator 74 may determine the vectors 40 and 50 that are respectively between the first imaging device 20 and the focus of interest 10 and the second imaging device 30 and the focus of interest 10. The vector generator 74 may use GPS coordinates in addition to compass information about direction from the imaging devices 20 and 30 to the focus of interest 10 to calculate the vectors 40 and 50. As an imaging device changes location, new vectors may be generated that may indicate the magnitude and direction of the orientation between that imaging device and the focus of interest 10.

The three-dimensional image generator 76 may create a three-dimensional image from at least a first image from the first imaging device 20 and at least a second image from the second imaging device 30. As used herein, the expression “three-dimensional image” may relate to any image that provides a viewer a perception of depth. The method of creating a three-dimensional image will be discussed in further detail below.

Turning now to FIG. 3, and with continued reference to FIGS. 1 and 2, a method 300 is shown. The method 300 may be implemented as one or more modules in executable software as a set of logic instructions stored in a machine- or computer-readable storage medium of a memory such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 310 provides for managing a session to receive at least a first image from the first imaging device 20 and a second image from the second imaging device 30. The session may be initiated in response to one or more user requests to initiate an image-sharing session of a focal point of interest 10. Such a request may be made through an application on the first imaging device 20 (an “app”) when a user attends an event with the focal point of interest 10 and wishes to begin capturing images. The session management controller 72 coordinates requests from all users with imaging devices wishing to capture images of the focal point of interest 10. In doing so, the session management controller 72 may reserve a high speed, low latency channel for transmission of images and communication with all of the imaging devices that join the session.

In one embodiment, the session management controller 72 may employ user synchronization to enhance the quality of the three-dimensional images to be generated. The imaging device 20 and the imaging device 30 may transmit GPS coordinate information plus compass information about direction to the session management controller 72. Alternatively, in the absence of compass information, the imaging device 20 may generate a pair of GPS coordinate locations in the direction of the focus of interest 10 from which the imaging device 20 or the session management controller 72 may calculate the direction of view. In another alternative, the location of the imaging device 20 or the imaging device 30 may be determined by the base station 80 as part of a triangulation process with other base stations and in connection with image content that may be made known to the session management controller 72. As used herein, the expression “base station” may relate to any type of central signal receiving point including e-Node-B, WLAN (Wireless Local Area Network), Wi-Fi hot spot, etc.

The session management controller 72 may wirelessly communicate with the imaging device 20 or the imaging device 30 to request further image or focus of interest 10 information. The session management controller 72 may request local control of the imaging device 20 or the imaging device 30 and capture one or more images to be wirelessly communicated to itself. The session management controller 72 may facilitate communication among imaging devices participating in any given imaging session through, for example, a “chat” type of feature or any other communication among imaging devices. The session management controller 72 may suggest imaging device settings to the imaging device 20 or the imaging device 30 or any other imaging device participating in the session. The session management controller 72 may also search databases for information regarding any objects within the focus of interest 10 to use for image calibration (e.g., known geometry information about fixed objects for distance measurements and rendering of image content). Other searches may be performed concerning weather conditions at the coordinates of focus of interest 10 or any other factor than may impact imaging. Results of the searches may be communicated to any imaging devices in the session and may suggest objects as focal points of interest or imaging device settings based on the search results. The session management controller 72 may also receive at least a first image from the first imaging device 20 and at least a second image from the second imaging device 30.

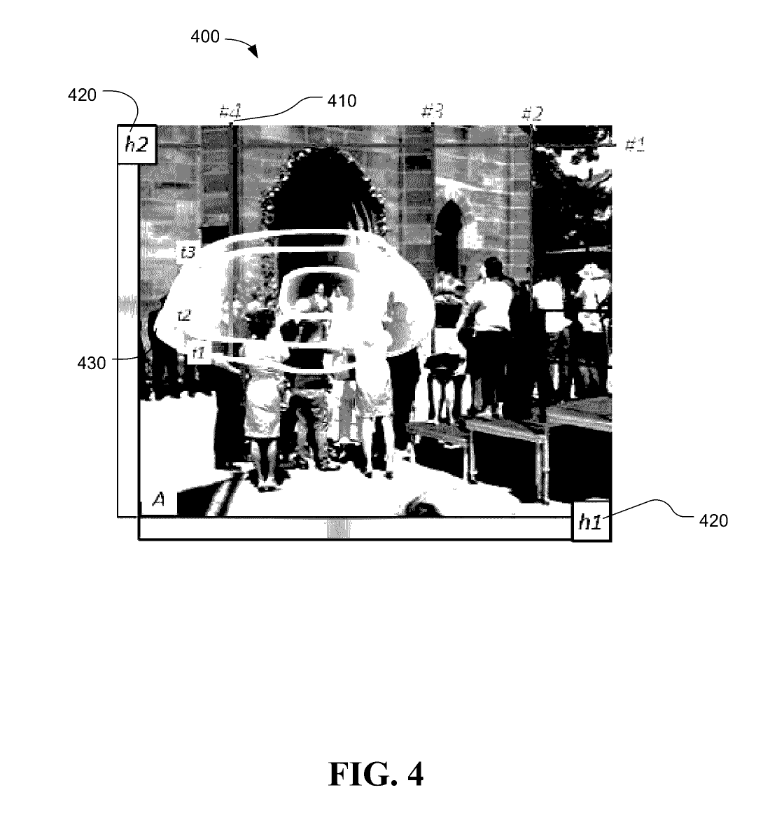

In an exemplary embodiment, the session management controller 72 may transmit an image marked with statistical information to an imaging device, such as the first imaging device 20 or the second imaging device 30. An exemplary image 400 marked with statistical and other information is depicted in FIG. 4. Image 400 includes calibration lines 410, marked as #1, #2, #3, and #4. Typically, such calibration lines will be imposed on non-moving objects in an image. Here, the calibration lines 410 may align with architectural features of a building in the background, behind the focus of image 10 (e.g., the people exiting the building). These calibration lines 410 may be later used in image processing to generate a three-dimensional image.

Histogram bars 420, marked hl and h2, as well as contour lines 430, marked t1 to t3 may provide statistical information about the focus of interest (e.g., the area marked within the contour lines). A user of the imaging device 20, upon receiving the image 400, may use the image 400 to validate a current imaging device view against an earlier view from imaging device 20. While the histogram bars 420 illustrate distribution of focus in x-y coordinates over a period of time, the contour lines 430 may be used to combine information taken over several time steps, e.g., t1, t2, and t3. Further, the contour lines 430 may take into account actual focus settings among various imaging devices that are part of the imaging session.

In block 320, vectors 40 and 50 may be generated between the imaging device 20 and the focus of interest 10 and between the imaging device 30 and the focus of interest 10. Vector generation is performed, in part, from the information and images gathered by session management controller 72, as described above. The vector information may be used during processing to form a three-dimensional image, to be discussed in further detail below.

In illustrated block 330, a three-dimensional image is generated from at least the first image from the first imaging device 20 and the second image from the second imaging device 30. Note that the three-dimensional image may also be formed from multiple images from an individual imaging device. Video may be included in the term “image” as used herein. In block 330, the images may be received directly from the imaging devices 20 and 30 or they may be received through the session management controller 72 by way of vector generating block 320 or directly from block 310. With upload of the first image, evaluation of image content may begin for eventual creation of a three-dimensional image. Images from different imaging devices (e.g., imaging device 20 and imaging device 30) are considered in order to generate the spatial domain. Vectors 40 and 50 may give a precise measurement and orientation of the respective imaging devices 20 and 30 to the focus of interest 10. Generation of the three-dimensional image may include combination, interpolation, as well as transformation of data. The processing may incorporate auxiliary data such as the exact position of a building and its metrics for accurate interpretation of the calibration lines 410 as well as absolute and relative distance and direction. Block 330 may suggest improvements by instructing the session management controller 72 to cause one or more imaging devices to take additional images, either of focus of interest 10 or objects in the background for calibration. Generation of a three-dimensional image may also include removal of unwanted information such as removal of individuals, license plates, etc.

In one aspect, generation of three-dimensional images may include use of software-based “image stitching” and image projection. Commercially available software may be selected for use. In image stitching, multiple images may be combined with overlapping regions carefully matched to create a cohesive image. In the overlapping images, control points may be selected that may precisely overlay one another in the final image. In this process, each image's angle of view is considered using perspective references such as straight lines, a horizon, or a vanishing point. In image projection, a flat image may be mapped onto a curved surface or vice versa as in panoramic photography. Because different vectors are involved for different images, image scaling may be used to resize images prior to image stitching or image projection. In image scaling, an image size may be changed so that various objects within an image become the same size, suitable for image stitching. In additional to image scaling, much more advanced processing techniques may take into account effects caused by the position and setting of imaging device 20 and imaging device 30, eventually creating a virtual camera position(s) from which the focus of interest 10 is observed. Following generation of one or more three-dimensional images, the generated image(s) may be transmitted to the imaging device 20 and the imaging device 30 or a link may be made available for downloading of images.

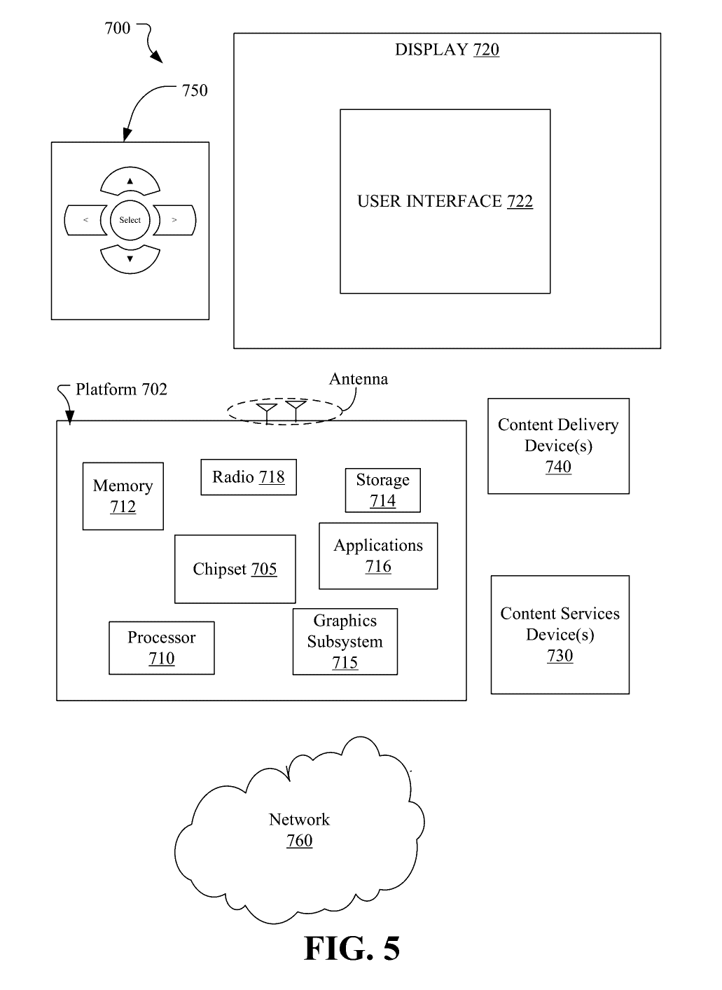

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth. Thus, the system 700 may be used to perform three-dimensional advanced imaging as described herein.

In embodiments, the system 700 comprises a platform 702 coupled to a display 720 that presents visual content. The platform 702 may receive video bitstream content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, the platform 702 may comprise any combination of a chipset 705, processor 710, memory 712, storage 714, graphics subsystem 715, applications 716 and/or radio 718 (e.g., network controller). The chipset 705 may provide intercommunication among the processor 710, memory 712, storage 714, graphics subsystem 715, applications 716 and/or radio 718. For example, the chipset 705 may include a storage adapter (not depicted) capable of providing intercommunication with the storage 714.

The processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 710 may comprise dual-core processor(s), dual-core mobile processor(s), and so forth.

The memory 712 may be implemented as a volatile memory device such as, but not limited to, a Random Access Memory (RAM), Dynamic Random Access Memory (DRAM), or Static RAM (SRAM).

The storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

The graphics subsystem 715 may perform processing of images such as still or video for display. The graphics subsystem 715 may be a graphics processing unit (GPU) or a visual processing unit (VPU), for example. An analog or digital interface may be used to communicatively couple the graphics subsystem 715 and display 720. For example, the interface may be any of a High-Definition Multimedia Interface, DisplayPort, wireless HDMI, and/or wireless HD compliant techniques. The graphics subsystem 715 could be integrated into processor 710 or chipset 705. The graphics subsystem 715 could be a stand-alone card communicatively coupled to the chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 718 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, the display 720 may comprise any television type monitor or display. The display 720 may comprise, for example, a computer display screen, touch screen display, video monitor, television-like device, and/or a television. The display 720 may be digital and/or analog. In embodiments, the display 720 may be a holographic display. Also, the display 720 may be a transparent surface that may receive a visual projection. Such projections may convey various forms of information, images, and/or objects. For example, such projections may be a visual overlay for a mobile augmented reality (MAR) application. Under the control of one or more software applications 716, the platform 702 may display user interface 722 on the display 720.

In embodiments, content services device(s) 730 may be hosted by any national, international and/or independent service and thus accessible to the platform 702 via the Internet, for example. The content services device(s) 730 may be coupled to the platform 702 and/or to the display 720. The platform 702 and/or content services device(s) 730 may be coupled to a network 760 to communicate (e.g., send and/or receive) media information to and from network 760. The content delivery device(s) 740 also may be coupled to the platform 702 and/or to the display 720.

In embodiments, the content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

The content services device(s) 730 receives content such as cable television programming including media information, digital information, and/or other content. Examples of content providers may include any cable or satellite television or radio or Internet content providers. The provided examples are not meant to limit embodiments.

In embodiments, the platform 702 may receive control signals from a navigation controller 750 having one or more navigation features. The navigation features of the controller 750 may be used to interact with the user interface 722, for example. In embodiments, the navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 750 may be echoed on a display (e.g., display 720) by movements of a pointer, cursor, focus ring, or other visual indicators displayed on the display. For example, under the control of software applications 716, the navigation features located on the navigation controller 750 may be mapped to virtual navigation features displayed on the user interface 722, for example. In embodiments, the controller 750 may not be a separate component but integrated into the platform 702 and/or the display 720. Embodiments, however, are not limited to the elements or in the context shown or described herein.

In embodiments, drivers (not shown) may comprise technology to enable users to instantly turn on and off the platform 702 like a television with the touch of a button after initial boot-up, when enabled, for example. Program logic may allow the platform 702 to stream content to media adaptors or other content services device(s) 730 or content delivery device(s) 740 when the platform is turned “off” In addition, chipset 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 700 may be integrated. For example, the platform 702 and the content services device(s) 730 may be integrated, or the platform 702 and the content delivery device(s) 740 may be integrated, or the platform 702, the content services device(s) 730, and the content delivery device(s) 740 may be integrated, for example. In various embodiments, the platform 702 and the display 720 may be an integrated unit. The display 720 and content service device(s) 730 may be integrated, or the display 720 and the content delivery device(s) 740 may be integrated, for example. These examples are not meant to limit the embodiments.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

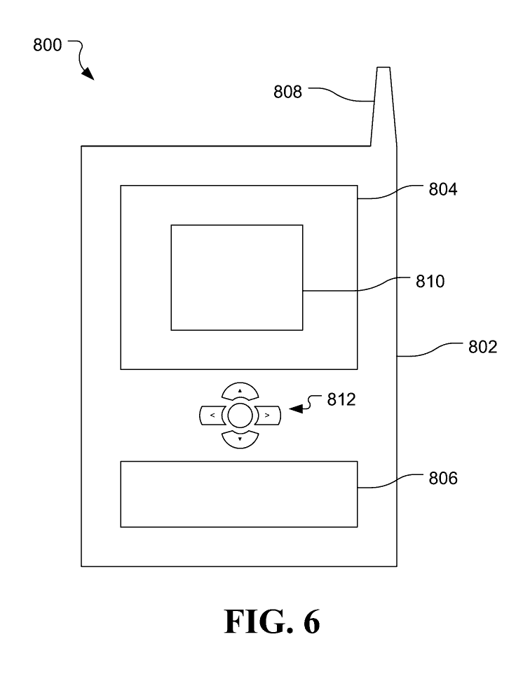

As described above, the system 700 may be embodied in varying physical styles or form factors. FIG. 6 illustrates embodiments of a small form factor device 800 in which the system 700 may be embodied. In embodiments, for example, the device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, the device 800 may comprise a housing 802, a display 804, an input/output (I/O) device 806, and an antenna 808. The device 800 also may comprise navigation features 812. The display 804 may comprise any suitable display unit for displaying information appropriate for a mobile computing device. The I/O device 806 may comprise any suitable I/O device for entering information into a mobile computing device. Examples for the I/O device 806 may include an alphanumeric keyboard, a numeric keypad, a touch pad, input keys, buttons, switches, rocker switches, microphones, speakers, voice recognition device and software, and so forth. Information also may be entered into the device 800 by way of microphone. Such information may be digitized by a voice recognition device. The embodiments are not limited in this context.

Additional Notes and Examples

Example 1 may include a three-dimensional imaging system comprising at least first and second imaging devices, an apparatus including a session management controller, a vector generator to determine one or more vectors between the first imaging device and a focus of interest and between the second imaging device and the focus of interest, and a three-dimensional image generator to receive at least a first image from the first imaging device and at least a second image from the second imaging device and generate a three-dimensional image based on the vectors and at least the first image and the second image.

Example 2 may include the system of Example 1, wherein the session management controller is to coordinate view perspectives of the first and second imaging devices.

Example 3 may include the system of Examples 1 or 2, wherein the first and second imaging devices include wireless transceivers.

Example 4 may include the system of Examples 1 or 2, wherein the processor is part of a wireless communication node.

Example 5 may include the system of Examples 1 or 2, wherein the session management controller is to provide imaging feedback to the first and second imaging devices.

Example 6 may include the system of Examples 1 or 2, wherein the session management controller is to remotely control imaging performed by the first and second imaging devices.

Example 7 may include a three-dimensional imaging apparatus comprising a session management controller, a vector generator to determine one or more vectors between a first imaging device and a focus of interest and between a second imaging device and the focus of interest, and a three-dimensional image generator to receive at least a first image from the first imaging device and at least a second image from the second imaging device and generate a three-dimensional image based on the vectors and at least the first image and the second image.

Example 8 may include the apparatus of Example 7, wherein the session management controller is to coordinate view perspectives of the first and second imaging devices.

Example 9 may include the apparatus of Examples 7 or 8, wherein the session management controller is to gather statistical information about the focus of interest.

Example 10 may include the apparatus of Examples 7 or 8, wherein the apparatus is part of a wireless communication node.

Example 11 may include the apparatus of Examples 7 or 8, wherein the session management controller is to provide imaging feedback to the first and second imaging devices.

Example 12 may include the apparatus of Examples 7 or 8, wherein the session management controller is to remotely control imaging performed by the first and second imaging devices.

Example 13 may include a three-dimensional imaging method comprising managing a session to receive at least a first image from a first imaging device and a second image from a second imaging device, generating one or more vectors between the first imaging device and a focus of interest and between the second imaging device and the focus of interest, and generating a three-dimensional image based on the vectors and at least the first image and the second image.

Example 14 may include the method of Example 13, wherein managing the session includes coordinating view perspectives of the first and second imaging devices.

Example 15 may include the method of Examples 13 or 14, wherein managing the session includes gathering statistical information about the focus of interest.

Example 16 may include the method of Examples 13 or 14, wherein managing the session includes communicating with the first and second imaging devices.

Example 17 may include the method of Examples 13 or 14, further including providing imaging feedback to the first and second imaging devices.

Example 18 may include the method of Examples 13 or 14, further including remotely controlling imaging performed by the first and second imaging devices.

Example 19 may include at least one computer readable storage medium comprising a set of instructions which, when executed by a computing device, cause the computing device to manage a session to receive at least a first image from a first imaging device and a second image from a second imaging device, generate one or more vectors between the first imaging device and a focus of interest and between the second imaging device and a focus of interest, and generate a three-dimensional image based on the vectors and at least the first image and the second image.

Example 20 may include the at least one computer readable storage medium of Example 19, wherein the instructions, when executed, cause a computing device to coordinate view perspectives of the first and second imaging devices.

Example 21 may include the at least one computer readable storage medium of Example 19 or 20, wherein the instructions, when executed, cause a computing device to gather statistical information about the focus of interest.

Example 22 may include the at least one computer readable storage medium of Examples 19 or 20, wherein the instructions, when executed, cause a computing device to wireless communicate with the first and second imaging devices.

Example 23 may include the at least one computer readable storage medium of Examples 19 or 20, wherein the instructions, when executed, cause a computing device to provide imaging feedback to the first and second imaging devices.

Example 24 may include the at least one computer readable storage medium of Examples 19 or 20, wherein the instructions, when executed, cause a computing device to remotely control imaging performed by the first and second imaging devices.

Example 25 may include a three-dimensional imaging apparatus comprising means for managing a session to receive at least a first image from a first imaging device and a second image from a second imaging device, means for generating one or more vectors between the first imaging device and a focus of interest and between the second imaging device and the focus of interest, and means for generating a three-dimensional image based on the vectors and at least the first image and the second image.

Example 26 may include the method of Example 25, further comprising means for coordinating view perspectives of the first and second imaging devices.

Example 27 may include the apparatus of claim 25 or 26, further comprising means for gathering statistical information about the focus of interest.

Example 28 may include the apparatus of Example 25 or 26, further comprising means for wirelessly communicating with the first and second imaging devices.

Example 29 may include the apparatus of Examples 25 or 26, further comprising means for providing imaging feedback to the first and second imaging devices.

Example 30 may include the apparatus of Examples 25 or 26, further comprising means for remotely controlling imaging performed by the first and second imaging devices.

Techniques may generate one or more three-dimensional images incorporating the perspectives of multiple imaging devices. Images may optionally be joined together to create a panoramic image prior to conversion to a three-dimensional image. Using multiple imaging device viewpoints, a large perspective view angle image may be obtained. The generated three-dimensional image may be interactive so that a user may select variable views according to personal interest and the device with which the three-dimensional image is viewed. Using the above embodiments, an ad hoc three-dimensional community may be formed to capture images of an event. Online visual chat may be used to improve the various imaging views that will be included in the generated three-dimensional image.

By forming an ad hoc community, users of imaging devices may decide cooperatively on the subject matter of the focus of interest. Through session management, processing resources and communication channels may be reserved to allow high speed image transfer and real time imaging decisions. By providing feedback information derived from overall image content, users may judge and improve upon imaging device settings for a current focus of interest. Image data combined with information on imaging device capabilities may be used for device pairing and for remote setting of camera control. Existing image content available from previous sessions or from Internet searches may be added to the generated three-dimensional image to enhance image quality or decrease processing time. Information about known geometry of fixed objects in an image may be used as calibration information to render the three-dimensional image, including information gained from sources other than image information (e.g., Internet search results regarding objects identified).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A system comprising:
at least first and second imaging devices; and
an apparatus including,
a session management controller,
a vector generator to determine one or more vectors between the first imaging device and a focus of interest and between the second imaging device and the focus of interest, and
a three-dimensional image generator to receive at least a first image from the first imaging device and at least a second image from the second imaging device and generate a three-dimensional image based on the vectors and at least the first image and the second image.

2. The system of claim 1, wherein the session management controller is to coordinate view perspectives of the first and second imaging devices.

3. The system of claim 1, wherein the first and second imaging devices include wireless transceivers.

4. The system of claim 1, wherein the apparatus is part of a wireless communication node.

5. The system of claim 1, wherein the session management controller is to provide imaging feedback to the first and second imaging devices.

6. The system of claim 1, wherein the session management controller is to remotely control imaging performed by the first and second imaging devices.

7. An apparatus comprising:
a session management controller;
a vector generator to determine one or more vectors between a first imaging device and a focus of interest and between a second imaging device and the focus of interest; and
a three-dimensional image generator to receive at least a first image from the first imaging device and at least a second image from the second imaging device and generate a three-dimensional image based on the vectors and at least the first image and the second image.

8. The apparatus of claim 7, wherein the session management controller is to coordinate view perspectives of the first and second imaging devices.

9. The apparatus of claim 7, wherein the session management controller is to gather statistical information about the focus of interest.

10. The apparatus of claim 7, wherein the apparatus is part of a wireless communication node.

11. The apparatus of claim 7, wherein the session management controller is to provide imaging feedback to the first and second imaging devices.

12. The apparatus of claim 7, wherein the session management controller is to remotely control imaging performed by the first and second imaging devices.

13. A method comprising:
managing a session to receive at least a first image from a first imaging device and a second image from a second imaging device;
generating one or more vectors between the first imaging device and a focus of interest and between the second imaging device and the focus of interest; and
generating a three-dimensional image based on the vectors and at least the first image and the second image.

14. The method of claim 13, wherein managing the session includes coordinating view perspectives of the first and second imaging devices.

15. The method of claim 13, wherein managing the session includes gathering statistical information about the focus of interest.

16. The method of claim 13, wherein managing the session includes communicating with the first and second imaging devices.

17. The method of claim 13, further including providing imaging feedback to the first and second imaging devices.

18. The method of claim 13, further including remotely controlling imaging performed by the first and second imaging devices.

19. At least one computer readable storage medium comprising a set of instructions which, when executed by a computing device, cause the computing device to:
manage a session to receive at least a first image from a first imaging device and a second image from a second imaging device;
generate vectors between the first imaging device and a focus of interest and between the second imaging device and a focus of interest; and
generate a three-dimensional image based on the vectors and at least the first image and the second image.

20. The at least one computer readable storage medium of claim 19, wherein the instructions, when executed, cause a computing device to coordinate view perspectives of the first and second imaging devices.

21. The at least one computer readable storage medium of claim 19, wherein the instructions, when executed, cause a computing device to gather statistical information about the focus of interest.

22. The at least one computer readable storage medium of claim 19, wherein the instructions, when executed, cause a computing device to wireless communicate with the first and second imaging devices.

23. The at least one computer readable storage medium of claim 19, wherein the instructions, when executed, cause a computing device to provide imaging feedback to the first and second imaging devices.

24. The at least one computer readable storage medium of claim 19, wherein the instructions, when executed, cause a computing device to remotely control imaging performed by the first and second imaging devices.
